(19) United States
(12) Patent Application Publication
(10) Pub. No.: US 2006/0074762 A1
(43) Pub. Date: Apr. 6, 2006

(54) Method and system for proportionalizing costs for a transaction

(76) Inventors: Richard F. Heising, Pembroke Pines, FL (US); Omar S. Khan, Pembroke Pines, FL (US)

Correspondence Address: Larry G. Brown;Motorola, Inc., Law Department, 8000 West Sunrise Boulevard, Fort Lauderdale, FL, 33322, US

(21) Appl. No.: 10/950,060

(22) Filed: Sep. 24, 2004

(51) Int. Cl. G06Q 30/00

(52) U.S. Cl. 705/26

(57) ABSTRACT

The invention concerns a method (300) for proportionalizing costs for a transaction. The method includes the steps of determining (312) a subtransactional selling price (410), a corresponding subtransactional quantity (420) and a total transactional amount (430), dividing (314) the product of the subtransactional selling price and the corresponding subtransactional quantity by the total transactional amount and multiplying (316) an amount determined from the dividing step by a transactional cost associated with the transaction to generate a proportionalized cost.

### BACKGROUND OF THE INVENTION

1. Field of the Invention

This invention relates in general to electronic commerce and more particularly to methods for determining transactional costs in electronic commerce.

2. Description of the Related Art

Many companies maintain Internet sites for purposes of selling merchandise or services. Some of the goods that are sold are produced by other companies. In many instances, the entity that owns the Internet site enters into agreements with the producers of the goods that are being sold on the site in which the site owner pays a fee to these companies. For example, the Internet site owner may sell a product for which another company owns some type of intellectual property right, and the two entities may enter into a revenue sharing agreement. Revenue may be shared each time a product is sold.

When conducting a transaction, particularly one occurring on an Internet site, certain costs must be deducted from the revenue that the two entities collect from the transaction. As an example, most consumers use credit cards to purchase items from the Internet, and credit card companies typically charge to the merchant for each transaction a fee based on a percentage amount of the order. This fee is subtracted from the money collected from the purchase, and the owner of the Internet site can forward a share of the remaining funds to the company that provided the sold goods.

For a single purchase of a single item, deducting the transactional costs from the amount of revenue is uncomplicated and a fair result is generated. When several items are involved, however, the process produces an inequitable outcome. For example, assume that a transactional fee of two and one-half percent is associated with the order conducted on an Internet site, and that a provider of an item sold on the site receives eighty percent of the revenue generated from the sale and the site owner receives the remaining twenty percent. If a single item is sold for $10.00, the item provider will receive eighty percent of $9.75, with the rest going to the site owner.

If several items are sold, however, the transactional fee is determined by multiplying the transactional fee percentage to the overall order amount. This transactional fee is applied to each of the items sold. Thus, if a $40.00 item is sold in addition to the $10.00 product described above, the transaction fee will be two and one-half percent of $50.00, or $1.25. In this arrangement, the owner of the Internet site will collect $1.25 in transaction costs for each good sold. In accordance with the previous example, the provider of the good will only collect eighty percent of $8.75 and eighty percent of $38.75. As a result, an excessive amount of fees are collected for these types of transactions.

### SUMMARY OF THE INVENTION

The present invention concerns a method for proportionalizing costs for a transaction in an electronic commerce system. The method includes the steps of determining a subtransactional selling price, a corresponding subtransactional quantity and a total transactional amount, dividing the product of the subtransactional selling price and the corresponding subtransactional quantity by the total transactional amount and multiplying an amount determined from the dividing step by a transactional cost associated with the transaction to generate a proportionalized cost.

The transactional cost can be determined by multiplying a transactional fee percentage by the total transactional amount. Also, the proportionalized cost for a first item is higher than the proportionalized cost for a second item if the first item has a subtotal that is higher than a subtotal for the second item. In another arrangement, the method can include the steps of subtracting the proportionalized cost from the product of the subtransactional selling price and the corresponding subtransactional quantity and multiplying the amount determined in the subtracting step by a predetermined revenue sharing parameter to generate a proportionalized revenue. The method can also include the steps of transmitting the proportionalized revenue to a product provider computer system and transmitting an amount of revenue equal to the transactional cost to a financial entity computer system.

Further, the subtransactional selling price can be associated with a product available for sale on an electronic commerce site. A first entity can own the electronic commerce site, and a second entity can provide the product available for sale. The first and second entities can share revenue generated from the sale of the product on the electronic commerce site. As an example, the product can be software that is downloadable to a telecommunications device. As another example, the transactional cost can be a fee to be paid to a financial entity.

The present invention also concerns a machine readable storage having stored thereon a computer program having a plurality of code sections executable by a machine. These executable code sections cause the machine to perform the steps of determining a subtransactional selling price, a corresponding subtransactional quantity and a total transactional amount, dividing the product of the subtransactional selling price and the corresponding subtransactional quantity by the total transactional amount and multiplying an amount determined from the dividing step by a transactional cost associated with the transaction to generate a proportionalized cost.

The present invention also concerns an electronic commerce system for proportionalizing costs for a transaction. The system includes an electronic shopping cart and a proportionalizing engine. The electronic shopping cart is programmed to determine a subtransactional selling price, a corresponding subtransactional quantity and a total transactional amount. The proportionalizing engine is programmed to divide the product of the subtransactional selling price and the corresponding subtransactional quantity by the total transactional amount and multiply an amount determined from the dividing step by a transactional cost associated with the transaction to generate a proportionalized cost. The system also includes suitable software and circuitry to carry out the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for proportionalizing costs in accordance with an embodiment of the inventive arrangements;

FIG. 2 illustrates some of the components of FIG. 1 in more detail in accordance with an embodiment of the inventive arrangements;

FIG. 3 illustrates a method for proportionalizing costs in accordance with an embodiment of the inventive arrangements; and

FIG. 4 illustrates information that can be displayed to a consumer when purchasing an item from the system of FIGS. 1 and 2 in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

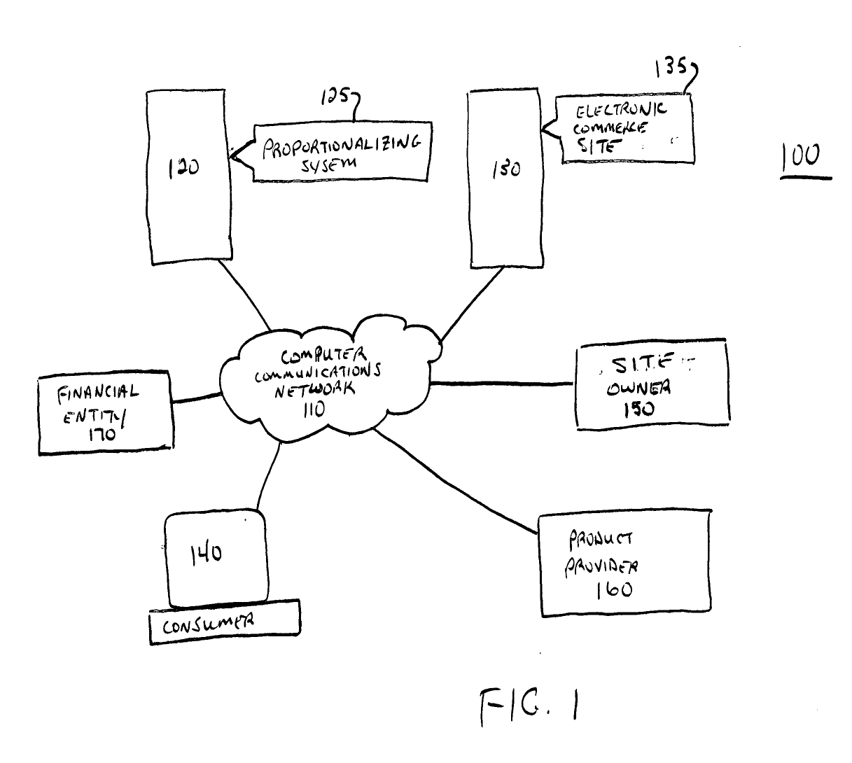

Referring to FIG. 1, an example of an electronic commerce system 100 for proportionalizing costs for a transaction is shown. The system 100 can include a computer communications network 110, a server 120, another server 130, a consumer computer system 140, a site owner computer system 150, a product provider computer system 160 and a financial entity computer system 170. As an example, the computer communications network can be the Internet, where communication can be facilitated using TCP/IP, HTTP and FTP protocols, as is well known in the art. Alternatively, communication can be facilitated through direct network access, a local area network or a wide area network. It is understood, however, that any suitable method of connecting computers in a network and any suitable network protocol for information exchange can be used to practice the inventive arrangements.

In one arrangement, the server 120 can include a proportionalizing system 125, and the server 130 can have an electronic commerce site (e-commerce site) 135. The servers 120 and 130 can be application servers, commerce servers, database servers or any other server that can operate on the computer communications network 110. As an example, the e-commerce site 135 can be a Web site configured to sell items or otherwise conduct commerce via the computer communications network 110. In another arrangement, and as those of ordinary skill in the art will appreciate, the e-commerce site can be a back-end processing system for processing financial transactions received from point-of-sale computer systems or other remote computer systems.

Using the consumer computer system 140, a consumer can visit the e-commerce site 135 via the computer communications network 110 to purchase items offered for sale on the e-commerce site 135. In addition, the owner of or the entity that maintains the e-commerce site 135 can access the e-commerce site 135 or the proportionalizing system 125 through the site owner computer system 150 for purposes of performing administrative functions on these systems. As those of skill in the art will appreciate, the proportionalizing system 125 and the e-commerce site 135 can include suitable security protocols for preventing unauthorized access.

In one embodiment of the invention, a product provider can manufacture or otherwise provide products to the owner of the e-commerce site 135. These products can be offered for sale on the e-commerce site 135. In return, the owner of the e-commerce site 135 can share with the product provider revenue that is generated from the sale of these products. In addition, because credit or debit cards may be used to consummate the sale of the products, the owner of the e-commerce site 135 can forward transaction fees to a financial entity, such as a bank or credit card company. As an example, the e-commerce site 135 can be a Web site that offers products or services associated with telecommunications devices. As a more specific example, the e-commerce site 135 can offer software that can be downloaded to a cellular telephone. Of course, it is understood that the invention is not limited in this regard, as any other suitable goods or services can be offered for sale on the e-commerce site 135.

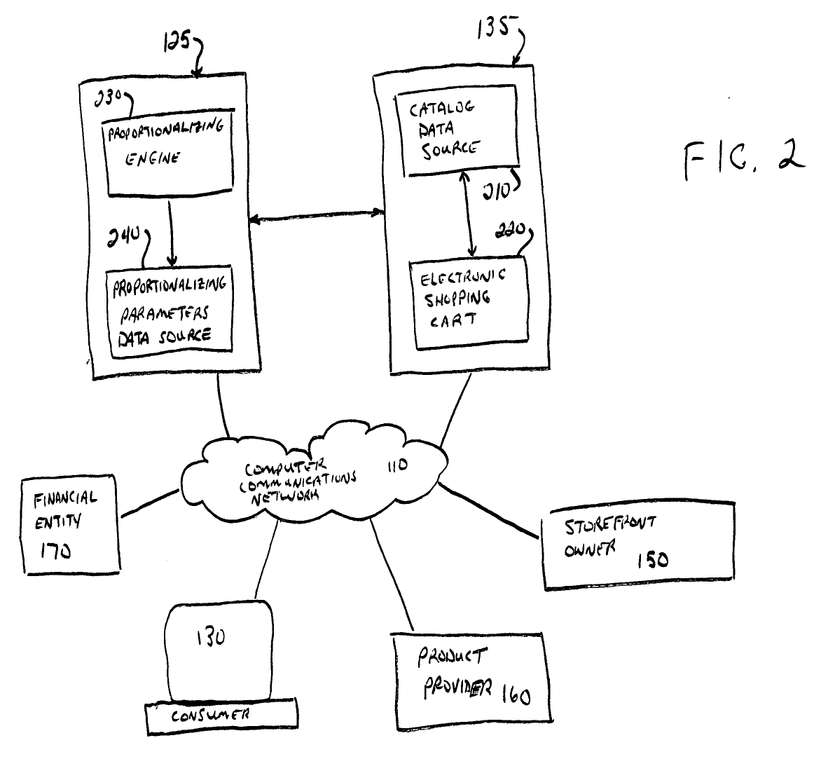

Referring to FIG. 2, a schematic diagram of one embodiment of the invention including the proportionalizing system 125 and the e-commerce site 135 is shown. Although the components shown in FIG. 2 can be distributed across multiple computer systems within a computer network, the proportionalizing system 125 and the e-commerce site 135 can also be contained within a single computer system.

The e-commerce site 135 can include a catalog data source 210 and an electronic shopping cart 220. The catalog data source 210 can include an inventory of items that are sold on the e-commerce site 135. The owner of the e-commerce site 135, or any other suitable entity, can load the inventory of items into the catalog data source 210 through the site owner computer system 150, or any other suitable computer system. As mentioned earlier, at least a portion of these items can be provided by a separate entity, such as a producer or distributor of goods. Further, the electronic shopping cart 220 can be used to store items selected by a consumer from the catalog data source 210 for a purchase transaction. As will be explained below, the electronic shopping cart 220 can be programmed to also determine a subtransactional selling price, a corresponding subtransactional quantity and a total transactional amount. These values can be used to help calculate a proportionalized transaction cost.

The proportionalizing system 125 can include a proportionalizing engine 230 and a proportionalizing parameters data source 240. The proportionalizing parameters data source 240 can include one or more parameters that can be used to calculate the amount of revenue that is to be forwarded to a product provider whose goods are being sold on the e-commerce site 135. For example, each product provider may receive a certain percentage of the revenue generated from the sale of one of that provider's goods. This percentage amount, which can also be referred to as a predetermined revenue sharing parameter, may be stored in the proportionalizing parameters data source 240. A transaction fee percentage, which can be applied to the cost of items being sold on the e-commerce site 135 when a card issued by a financial entity is used to purchase such items on the e-commerce site 135, can also be stored in the proportionalizing parameters data source 240. It must be noted that the invention is not limited to these examples, as any other suitable data or parameters can be stored in the proportionalizing data source 240.

The proportionalizing engine 230 can access data from the electronic shopping cart 220 and one or more parameters from the proportionalizing parameters data source 240 and can be programmed to calculate a proportionalized cost. Once the proportionalized cost is generated, the proportionalizing engine 230 can determine the amount of revenue that is to be directed to the owner of the e-commerce site 135 and the product provider, if these two entities are sharing revenue from the sale. The server 120 (see FIG. 1) can then transmit over a secure connection the appropriate revenue to the site owner computer system 150 and the product provider computer system 160, or to any other suitable computer system. The server 120 (see FIG. 1) can also transfer over a secure connection the appropriate transactional fee to the financial entity computer system 170. This process will be described in more detail below.

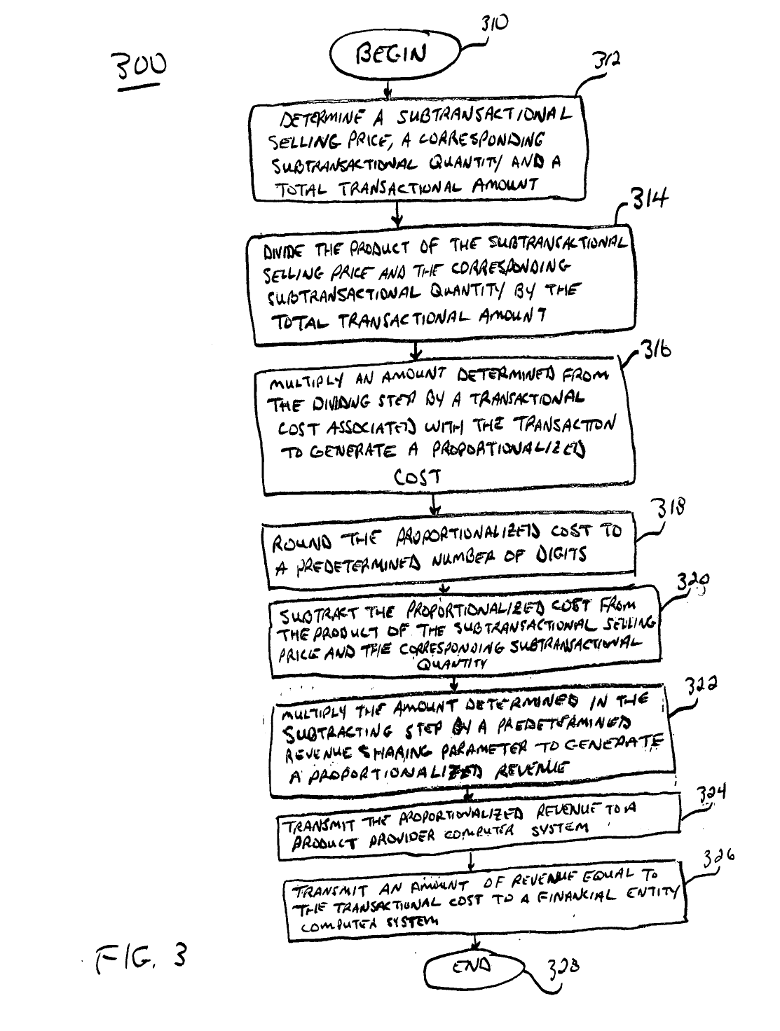

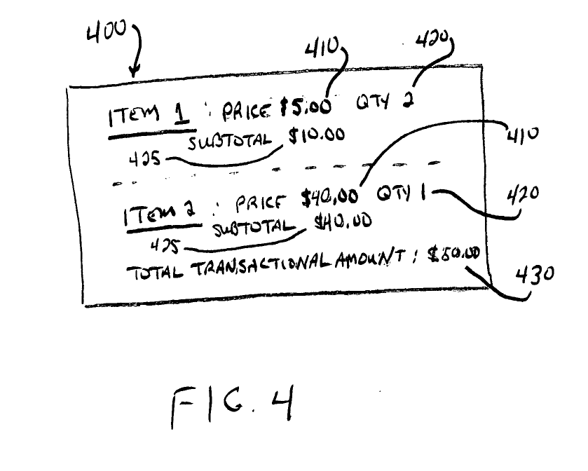

Referring to FIG. 3, a method 300 for proportionalizing costs for a transaction in an e-commerce system is shown. When describing the steps of the method 300, reference will be made to the components of FIGS. 1 and 2. It is understood, however, that the method 300 can be practiced in any other suitable system. To further describe the method 300 of FIG. 3, reference will also be made to FIG. 4, which shows a set of information 400 relating to the sale of several items that can be displayed to a consumer.

At step 310, the method 300 can begin. At step 312, a subtransactional selling price, a corresponding subtransactional quantity and a total transactional amount can be determined. For example, referring to FIGS. 2 and 4, a consumer can access the e-commerce site 135 through the consumer computer system 140 and the computer communications network 110. At the e-commerce site 135, the user can select for purchase any suitable number and type of items. These items can be accessed from the catalog data source 210. The catalog data source 210 can also store any suitable type of information about the selected items to consummate the sale, such as the price of the article and its availability.

Once selected, the electronic shopping cart 220 can access from the catalog data source 210 the price of the items and the quantity of the items to ensure that they are in stock. As an example, two items are selected in FIG. 4. These items can be provided by a product provider that is a single entity or from separate entities. Based on the consumer's selections, the electronic shopping cart 220 determines a subtransactional selling price 410, a corresponding subtransactional quantity 420 and a total transactional amount 430. The electronic shopping cart 220 can also determine a subtotal 425. For purposes of the invention, the subtransactional selling price 410 can be the selling price of a selected item as listed in the catalog data source 210 (or any other suitable database). Additionally, the corresponding subtransactional quantity 420 can be the total units of a particular item selected for purchase by the consumer. The total transactional amount 430 can be the total cost of the purchase of the items that is to be billed to the consumer. The subtotal 425 can be the product of the subtransactional selling price 410 of a selected item and the corresponding subtransactional quantity 420 of that item.

For example, in FIG. 4, the subtransactional selling price 410 can be $5.00 for item 1 and the subtransactional selling price for item 2 can be $40.00. The corresponding subtransactional quantities for these items can be 2 and 1, respectively. Finally, the total transactional amount can be $50.00, which is the cost of the item 1 purchase added to the cost of the item 2 purchase.

Moving back to FIG. 3, at step 314, the product of the subtransactional selling price and the corresponding subtransactional quantity can be divided by the total transactional amount. At step 316, the amount determined from step 314 can be multiplied by a transactional cost associated with the transaction to generate a proportionalized cost. The proportionalized cost can then be rounded to a predetermined number of digits, as shown at step 318.

For example, referring once again to FIGS. 2 and 4, for each item to be sold, the proportionalizing engine 230 can garner the subtransactional selling price 410, the corresponding subtransactional quantity 420 and the total transactional amount 430 from the electronic shopping cart 220. The proportionalizing engine 230 can also access a transactional cost percentage associated with the purchase from the proportionalizing parameters data source 240. The proportionalizing engine 230, for each item, can then divide the product of the subtransactional selling price 410 and the corresponding subtransactional quantity 420 by the total transactional amount 430. In addition, the proportionalizing engine 230 can multiply the transactional cost percentage by the total transactional amount 430 to obtain a transactional cost.

Once these amounts are, calculated, the proportionalizing engine 230 can multiply the amount determined from the dividing step by the transactional cost. The transactional cost can be the fee charged by a financial entity in exchange for the assistance of the financial entity in consummating the transaction. As an example, the transactional cost can be the fee charged by a credit card company or a bank to a merchant when a consumer uses a financial card, such as a credit or debit card for the purchase of goods or services from the merchant. In this example, a transaction cost percentage of two and one-half percent will be assumed, although any other suitable value is within contemplation of the inventive arrangements. As such, the transaction cost can be $1.25 (2.5%×$50.00) for this example.

Concerning the two items being bought in FIG. 4, for item 1, the proportionalized cost is determined as follows:
[($5.00×2)/($50.00)]×$1.25=$0.25.
For item 2, the proportionalized cost is as follows:
[($40.00×1)/($50.00)]×$1.25=$1.00.
If necessary, both of the values can then be rounded or truncated to two digits although the proportionalized costs can be rounded or truncated to any other suitable number of digits. Rounding or truncating is not necessary in this example. As shown above, the proportionalized cost for the subtotal 425 of an item that costs more (e.g., item 2) can be higher than the proportionalized cost of the item that has a lower subtotal (e.g., item 1). As will be described below, this feature of the invention can result in a more equitable distribution of revenue.

Referring back to the method 300 of FIG. 3, at step 320, the proportionalized cost can be subtracted from the product of the subtransactional selling price and the corresponding subtransactional quantity. Further, at step 322, the amount determined in this subtracting step can be multiplied by a predetermined revenue sharing parameter to generate a proportionalized revenue.

For example, referring once again to FIGS. 2 and 4, the proportionalizing engine 230 can subtract the proportionalized cost from the product of the subtransactional selling price 410 and the corresponding subtransactional quantity 420. The proportionalizing engine 230 can then multiply this amount by a predetermined revenue sharing parameter, which can be accessed from the proportionalizing parameters data source 240. As an example, the predetermined revenue sharing parameter can be a predetermined percentage. Completion of these two steps can produce the proportionalized revenue. A first entity can pay this proportionalized revenue to a second entity, such as a product provider or other vendor, in exchange for the second entity supplying products to be sold by the first entity.

To illustrate the operation of generating a proportionalized revenue, reference will be made to the examples described above in relation to FIG. 4. An assumption will be made in which the predetermined revenue sharing parameter for item 1 is eighty percent and for item 2 is fifty percent, although it is understood that any other suitable parameters can be used with the invention. Specifically, for item 1, the proportionalized revenue is determined as follows:
[($5.00×2)−$0.25]×0.8=$7.80.
For item 2, the proportionalized revenue is determined as follows:
[($40.00×1)−$1.00]×0.50=$19.50.
If necessary, these proportionalized revenues can be rounded to a predetermined number of digits. In another arrangement, they may be truncated.

In either example, a larger amount of revenue is generated from the sale because less money is earmarked for the payment of transactional costs. For example, if the transactional fees were not proportionalized, i.e., no proportionalized costs were determined, the provider of item 1 would have received only $7.00. This $7.00 total represents the amount of money spent on item 1 ($10.00) minus the non-proportionalized transactional fee ($1.25) multiplied by the predetermined revenue sharing parameter (0.8). Similarly, the provider of item 2 would have received only $19.38, which represents the total amount spent of item 2 ($40.00) minus the non-proportionalized transactional fee ($1.25) multiplied by the predetermined revenue sharing parameter (0.5). In view of the greater amount of revenue generated for the product providers, there is a greater incentive for such entities to supply a larger number of products for sale.

As illustrated above, a greater amount of the transactional fee can be deducted from the revenue of the item that has a higher subtotal 425. Specifically, the proportionalized cost of the item with the higher subtotal 425 can be higher than the proportionalized cost of the item with the lower subtotal 425. In the example above, a proportionalized cost of $1.00 is deducted from the $40.00 item (item 2) before the proportionalized revenue is determined. In addition, a proportionalized cost of $0.25 is deducted from the $10.00 item (item 1) before the proportionalized revenue is found. Because more revenue is collected from the items with the higher subtotals 425, the proportionalized costs for such products can be higher to make for a more equitable distribution of revenue, particularly if the product providers supplying these items are separate entities.

Referring back to the method 300 of FIG. 3, at step 324, the proportionalized revenue can be transmitted to a product provider computer system. At step 326, an amount of revenue equal to the transactional cost can be transmitted to a financial entity computer system. The method 300 can then end at step 328.

As an example, referring to FIG. 1, once the proportionalized revenue is determined, the server 120 can forward the proportionalized revenue through the computer communications network 110 to the product provider computer system 160. In another arrangement, the server 120 can instruct another computer system to direct the proportionalized revenue to the product provider computer system 160. Those of ordinary skill in the art will understand that there are myriad ways in which to transfer such revenue to the product provider computer system 160, and the invention is not limited to any particular method. It must also be noted that the revenue can be transmitted at the moment of the sale or following a predetermined amount of time. Moreover, the proportionalized revenue can be transmitted to a computer system other than the product provider computer system 160.

In one arrangement, the product provider computer system 160 can be owned and maintained by a product provider. A product provider can be any entity that offers products for sale on the e-commerce site 135. These products can be goods and/or services.

As another example, the server 120 can forward an amount of revenue equal to the transactional cost through the computer communications network 110 to the financial entity computer system 170. Alternatively, the server 120 can instruct another computer system to direct the transactional cost to the product provider computer system 160. In accordance with the example relating to FIG. 4 described above, a total of $1.25 ($0.25+$1.00) can be forwarded to the financial entity computer system 170. The transactional cost, like the proportionalized revenue, can be transmitted at the time of the sale or following a predetermined amount of time. Also, the transactional cost can be transmitted to a computer system other than the financial entity system 170.

As noted earlier, the transactional cost can be the fee associated with conducting a transaction with a financial card issued by a financial institution, such as a bank or credit card company. The financial entity computer system 160 can be owned and operated by any suitable financial institution.

In addition, while the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. In an electronic commerce system, a method for proportionalizing costs for a transaction, comprising the steps of:
determining a subtransactional selling price, a corresponding subtransactional quantity and a total transactional amount;
dividing the product of the subtransactional selling price and the corresponding subtransactional quantity by the total transactional amount; and
multiplying an amount determined from the dividing step by a transactional cost associated with the transaction to generate a proportionalized cost.

2. The method according to claim 1, wherein the transactional cost is determined by multiplying a transactional fee percentage by the total transactional amount.

3. The method according to claim 1, wherein the proportionalized cost for a first item is higher than the proportionalized cost for a second item if the first item has a subtotal that is higher than a subtotal for the second item.

4. The method according to claim 1, further comprising the steps of:
subtracting the proportionalized cost from the product of the subtransactional selling price and the corresponding subtransactional quantity;
multiplying the amount determined in the subtracting step by a predetermined revenue sharing parameter to generate a proportionalized revenue; and
transmitting the proportionalized revenue to a product provider computer system.

5. The method according to claim 1, further comprising the step of transmitting an amount of revenue equal to the transactional cost to a financial entity computer system.

6. The method according to claim 1, wherein the subtransactional selling price is associated with a product available for sale on an electronic commerce site.

7. The method according to claim 6, wherein a first entity owns the electronic commerce site and a second entity provides the product available for sale and wherein the first and second entities share revenue generated from the sale of the product on the electronic commerce site.

8. The method according to claim 6, wherein the product is software that is downloadable to a telecommunications device.

9. The method according to claim 1, wherein the transactional cost is a fee to be paid to a financial entity.

10. A machine readable storage having stored thereon a computer program having a plurality of code sections executable by a machine for causing the machine to perform the steps of:
determining a subtransactional selling price, a corresponding subtransactional quantity and a total transactional amount;
dividing the product of the subtransactional selling price and the corresponding subtransactional quantity by the total transactional amount; and
multiplying an amount determined from the dividing step by a transactional cost associated with the transaction to generate a proportionalized cost.

11. The machine readable storage according to claim 10, wherein the transactional cost is determined by multiplying a transactional fee percentage by the total transactional amount.

12. The machine readable storage according to claim 10, wherein the proportionalized cost for a first item is higher than the proportionalized cost for a second item if the first item has a subtotal that is higher than a subtotal for the second item.

13. The machine readable storage according to claim 10, wherein the executable code sections further cause the machine to perform the steps of:
subtracting the proportionalized cost from the product of the subtransactional selling price and the corresponding subtransactional quantity;
multiplying the amount determined in the subtracting step by a predetermined revenue sharing parameter to generate a proportionalized revenue; and
transmitting the proportionalized revenue to a product provider computer system.

14. The machine readable storage according to claim 10, wherein the executable code sections further cause the machine to perform the step of transmitting an amount of revenue equal to the transactional cost to a financial entity computer system.

15. The machine readable storage according to claim 10, wherein the subtransactional selling price is associated with a product available for sale on an electronic commerce site.

16. The machine readable storage according to claim 10, wherein the transactional cost is a fee to be paid to a financial entity.

17. An electronic commerce system for proportionalizing costs for a transaction, comprising:
an electronic shopping cart, wherein the electronic shopping cart is programmed to determine a subtransactional selling price, a corresponding subtransactional quantity and a total transactional amount; and
a proportionalizing engine, wherein the proportionalizing engine is programmed to:
divide the product of the subtransactional selling price and the corresponding subtransactional quantity by the total transactional amount; and
multiply an amount determined from the dividing step by a transactional cost associated with the transaction to generate a proportionalized cost.

18. The system according to claim 17, wherein the proportionalizing engine is further programmed to determine the transactional cost by multiplying a transactional fee percentage by the total transactional amount.

19. The system according to claim 17, wherein the proportionalized cost for a first item is higher than the proportionalized cost for a second item if the first item has a subtotal that is higher than a subtotal for the second item.

20. The system according to claim 17, further comprising a proportionalizing parameters data source and a product provider computer system, wherein the proportionalizing engine is further programmed to:
subtract the proportionalized cost from the product of the subtransactional selling price and the corresponding subtransactional quantity;
multiply the amount determined in the subtracting step by a predetermined revenue sharing parameter to generate a proportionalized revenue; and
transmit the proportionalized revenue to the product provider computer system;
wherein the proportionalizing parameters data source stores the transactional cost and the predetermined revenue sharing parameter.

21. The system according to claim 17, further comprising a financial entity computer system, wherein the proportionalizing engine is further programmed to transmit an amount of revenue equal to the transactional cost to the financial entity computer system.

22. The system according to claim 17, further comprising an electronic commerce site having a catalog data source, wherein the subtransactional selling price is associated with a product available for sale on the electronic commerce site and wherein the product is one of a number of items included in the catalog data source.

23. The system according to claim 22, wherein a first entity owns the electronic commerce site and a second entity provides the product available for sale and wherein the first and second entities share revenue generated from the sale of the product on the electronic commerce site.

24. The system according to claim 22, wherein the product is software that is downloadable to a telecommunications device.

25. The system according to claim 15, wherein the transactional cost is a fee to be paid to a financial entity.
